(19) United States
(12) Patent Application Publication
(10) Pub. No.: US 2022/0222730 A1
(43) Pub. Date: Jul. 14, 2022

(54) METHODS AND SYSTEMS FOR FACILITATING PROVIDING ASSISTANCE TO A USER WITH SHOPPING

(71) Applicant: Ofek Kessel, Sosua (DO)

(72) Inventor: Ofek Kessel, Sosua (DO)

(73) Assignee: Fierce Capital Investment Inc, Panama City (PA)

(21) Appl. No.: 17/471,110

(22) Filed: Sep. 9, 2021

Related U.S. Application Data
(60) Provisional application No. 63/136,945, filed on Jan. 13, 2021.

(51) Int. Cl. G06Q 30/06; G06N 20/00; G06F 16/951; G06F 40/51

(52) U.S. Cl. CPC G06Q 30/0631; G06Q 30/0627; G06Q 30/0629; G06F 40/51; G06N 20/00; G06F 16/951; G06Q 30/0603

(57) ABSTRACT

Disclosed herein is a method for facilitating providing assistance to a user with shopping. Accordingly, the method may include receiving a product query from a user device, identifying products based on the product identifier, retrieving catalogs associated with the products based on the identifying of the products, analyzing the catalogs using an algorithm, generating product information based on the detecting, analyzing the product information based on the generating of the product information, determining a value of a metric associated with the shopping based on the analyzing of the product, determining a goodness of a deal associated with each product in a category based on the value of the metric, identifying a product from the products based on the determining of the goodness of the deal, generating a recommendation for the shopping of the product based on the identifying of the product, and transmitting the recommendation to the user device.

### CROSS-REFERENCE TO RELATED APPLICATION

This application claims the benefit of U.S. Provisional Patent Application No. 63/136,945, titled “Methods And Systems For Assisting A User With Online Shopping”, filed Jan. 13, 2021, which is incorporated by reference herein in its entirety.

### FIELD OF THE INVENTION

Generally, the present disclosure relates to the field of data processing. More specifically, the present disclosure relates to methods and systems for facilitating providing assistance to a user with shopping.

### BACKGROUND OF THE INVENTION

The field of data processing is technologically important to several industries, business organizations, and/or individuals.

Nowadays when looking for a certain product to buy, users usually go to the websites of big merchants. Online shopping is often advantageous over traditional market shopping. Further, online shopping saves time and physical effort. Further, the users look for the price of the product on the websites to find the best deal for the product. Further, the users may browse and shop the product on the websites in a very short time.

Existing techniques for facilitating providing assistance to a user with shopping are deficient with regard to several aspects. For instance, current technologies do not find and compare the price of the product across the websites. Furthermore, current technologies do not recommend the best deal irrespective of the language of the websites simulating human vision.

Therefore, there is a need for improved methods and systems for facilitating providing assistance to a user with shopping that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating providing assistance to a user with shopping, in accordance with some embodiments. Accordingly, the method may include receiving, using a communication device, at least one product query from at least one user device. Further, the method may include identifying, using a processing device, a plurality of products based on the at least one product identifier. Further, the method may include retrieving, using a storage device, a plurality of catalogs associated with the plurality of products based on the identifying of the plurality of products. Further, the method may include analyzing, using the processing device, the plurality of catalogs using at least one algorithm. Further, the method may include generating, using the processing device, at least one product information associated with each product of the plurality of products based on the detecting. Further, the method may include analyzing, using the processing device, a plurality of the at least one product information associated with the plurality of products based on the generating of the at least one product information. Further, the method may include determining, using the processing device, at least one value of at least one metric associated with the shopping based on the analyzing of the plurality of the at least one product. Further, the method may include determining, using the processing device, a goodness of a deal associated with each product of the plurality of products in at least one category based on the at least one value of the at least one metric. Further, the method may include identifying, using the processing device, a product from the plurality of products based on the determining of the goodness of the deal. Further, the method may include generating, using the processing device, at least one recommendation for the shopping of the product based on the identifying of the product. Further, the method may include transmitting, using the communication device, the at least one recommendation to the at least one user device.

Disclosed herein is a system for facilitating providing assistance to a user with shopping, in accordance with some embodiments. Accordingly, the system may include a communication device configured for receiving at least one product query from at least one user device. Further, the communication device may be configured for transmitting at least one recommendation to the at least one user device. Further, the system may include a processing device communicatively coupled with the communication device. Further, the processing device may be configured for identifying a plurality of products based on the at least one product identifier. Further, the processing device may be configured for analyzing a plurality of catalogs using at least one algorithm. Further, the processing device may be configured for generating at least one product information associated with each product of the plurality of products based on the detecting. Further, the processing device may be configured for analyzing a plurality of the at least one product information associated with the plurality of products based on the generating of the at least one product information. Further, the processing device may be configured for determining at least one value of at least one metric associated with the shopping based on the analyzing of the plurality of the at least one product. Further, the processing device may be configured for determining a goodness of a deal associated with each product of the plurality of products in at least one category based on the at least one value of the at least one metric. Further, the processing device may be configured for identifying a product from the plurality of products based on the determining of the goodness of the deal. Further, the processing device may be configured for generating the at least one recommendation for the shopping of the product based on the identifying of the product. Further, the system may include a storage device communicatively coupled with the processing device. Further, the storage device may be configured for retrieving the plurality of catalogs associated with the plurality of products based on the identifying of the plurality of products.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating providing assistance to a user with shopping, in accordance with some embodiments.

FIG. 3 is a flowchart of a method for facilitating providing assistance to a user with shopping, in accordance with some embodiments.

FIG. 4 is a flowchart of a method for facilitating providing assistance to the user with shopping, in accordance with some embodiments.

FIG. 5 is a flowchart of a method for facilitating providing assistance to the user with shopping, in accordance with some embodiments.

FIG. 6 is a flowchart of a method for assisting a user with online shopping, in accordance with some embodiments.

FIG. 7 is a flowchart of a method for retraining the artificial intelligence model for assisting the user with online shopping, in accordance with some embodiments.

FIG. 8 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating providing assistance to a user with shopping, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), and a biometric sensor (e.g. a fingerprint sensor) associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating providing assistance to a user with shopping. Further, Artificial Intelligence (AI) shopper (an exemplary embodiment of the disclosed system herein) allows a user to find and compare prices of an item all across the web. Further, the user may want to shop for the item. Further, the disclosed system may show the price history associated with the item in specific shopping platforms. Further, the disclosed system may find similar product prices across the web. Further, the disclosed system may include may find/recommend deals all across the web applying Artificial Intelligence to simulate human vision. Further, the disclosed system may find and read product information from a listing similar to a human vision or Human reading. Further, the disclosed system may be associated with a software platform that may include an artificial intelligence application. Further, the artificial intelligence application may use computer vision, picture-to-text, and a smart machine learning positioning algorithm. Further, the disclosed system may be configured for reading a product catalog/page as a human does. Further, the disclosed system may be configured for detecting a name, a price, department, reviews, price attractiveness, product photo, and other media associated with the product. Further, the disclosed system may be configured for finding details irrespective of the position of the product in the product catalog. Further, the disclosed system may check if the deal, that may be listed in the product catalog, is good compared to other products and product reviews. Further, the disclosed system may show specific product prices from all around the web and recommend good deals listed in the product catalog without limitation of language or design of source.

Further, the artificial intelligence application may work together with a web-crawler. Further, the web crawler may find available products all across the web and extract products' information to be processed by the AI application.

Further, the disclosed system may be configured for detecting and reading the product catalog (or listing) using computer vision, image to text, and a unique positioning algorithm. Further, the disclosed system may be configured for price detection using a price detection algorithm. Further, the disclosed system may be configured for facilitating computer vision shopping. Further, the disclosed system may be configured for assisting the user in shopping. Further, the disclosed system allows the user to find and compare prices all across the web. show price history in specific shopping platforms.

Further, some conventional technologies find (scrape) information from a product's webpage based on HTML parsing. Further, scraping information from the webpage is limited as it is looking for name-specific values in a specific website code. Further, some conventional technologies do not support all websites and are not a support-all or a self-evolving solution.

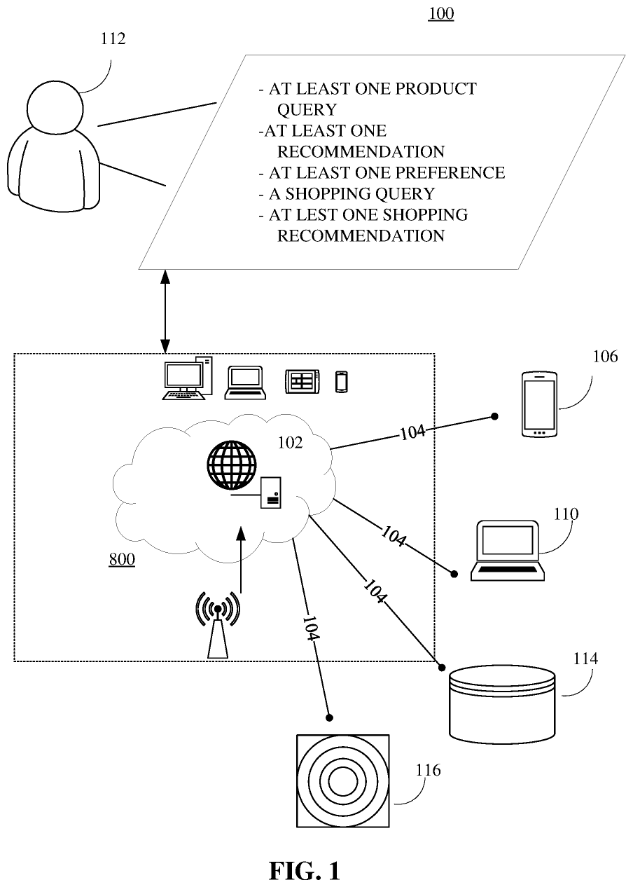

FIG. 1 is an illustration of an online platform 100 consistent with various embodiments of the present disclosure. By way of non-limiting example, the online platform 100 to facilitate providing assistance to a user with shopping may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 800.

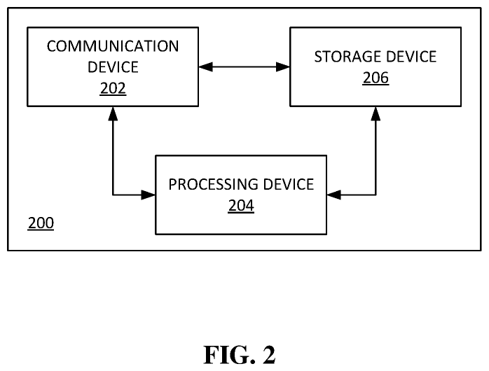

FIG. 2 is a block diagram of a system 200 for facilitating providing assistance to a user with shopping, in accordance with some embodiments. Accordingly, the system 200 may include a communication device 202 configured for receiving at least one product query from at least one user device. Further, the at least one product query may include at least one product identifier. Further, the at least one product identifier may include a product's name, a product's image, a product's code, etc. Further, the communication device 202 may be configured for transmitting at least one recommendation to the at least one user device.

Further, the system 200 may include a processing device 204 communicatively coupled with the communication device 202. Further, the processing device 204 may be configured for identifying a plurality of products based on the at least one product identifier. Further, the plurality of products may include items, articles, apparel, clothes, etc. Further, the plurality of products may be similar. Further, the plurality of products may be sold from a plurality of stores. Further, the processing device 204 may be configured for analyzing a plurality of catalogs using at least one algorithm. Further, the at least one algorithm may include at least one computer vision algorithm. Further, the at least one computer vision algorithm may be configured for detecting one or more product information objects present in each catalog of the plurality of catalogs. Further, the processing device 204 may be configured for generating at least one product information associated with each product of the plurality of products based on the detecting. Further, the processing device 204 may be configured for analyzing a plurality of the at least one product information associated with the plurality of products based on the generating of the at least one product information. Further, the processing device 204 may be configured for determining at least one value of at least one metric associated with the shopping based on the analyzing of the plurality of the at least one product. Further, the processing device 204 may be configured for determining a goodness of a deal associated with each product of the plurality of products in at least one category based on the at least one value of the at least one metric. Further, the processing device 204 may be configured for identifying a product from the plurality of products based on the determining of the goodness of the deal. Further, the processing device 204 may be configured for generating the at least one recommendation for the shopping of the product based on the identifying of the product. Further, the at least one recommendation may include at least one product information associated with the product.

Further, the system 200 may include a storage device 206 communicatively coupled with the processing device 204. Further, the storage device 206 may be configured for retrieving the plurality of catalogs associated with the plurality of products based on the identifying of the plurality of products.

Further, in some embodiments, the at least one algorithm may include at least one smart machine learning positioning algorithm. Further, the at least one smart machine learning positioning algorithm may be configured for determining at least one of a visual feature of each product information object of the one or more product information objects and a position of each product information object of the one or more product information objects in each catalog of the plurality of catalogs based on the detecting. Further, the at least one smart machine learning positioning algorithm may be configured for classifying the one or more product information objects into one or more information types based on at least one of the visual feature and the position of each product information object of the one or more product information objects. Further, the at least one smart machine learning positioning algorithm may be configured for identifying at least one product information object associated with at least one predetermined information type from each catalog of the plurality of catalogs based on the classifying. Further, the generating of the at least one product information may be based on the identifying of the at least one product information object.

Further, in some embodiments, the one or more product information objects may include one or more media objects present in each catalog of the plurality of catalogs. Further, the detecting of the one or more product information objects may include detecting the one or more media objects. Further, the generating of the at least one product information may be based on the detecting of the one or more media objects.

Further, in some embodiments, the at least one algorithm may include at least one media-to-text conversion algorithm. Further, the at least one media-to-text conversion algorithm may be configured for converting the one or more media objects into one or more textual objects based on the detecting of the one or more media objects. Further, the generating of the at least one product information may be based on the converting.

Further, in some embodiments, the processing device 204 may be configured for analyzing the at least one product query. Further, the processing device 204 may be configured for determining a language of the at least one product query. Further, the processing device 204 may be configured for translating the at least one product information into the language based on the determining of the language and the generating of the at least one product information. Further, the analyzing of the plurality of the at least one product information may be based on the translating.

Further, in some embodiments, the communication device 202 may be configured for receiving at least one preference of the user associated with the shopping from the at least one user device. Further, the processing device 204 may be configured for analyzing the at least one preference. Further, the processing device 204 may be configured for determining the at least one category based on the analyzing of the at least one preference. Further, the determining of the goodness of the deal associated with each product of the plurality of products in the at least one category may be based on the determining of the at least one category.

Further, in some embodiments, the retrieving of the plurality of catalogs may include retrieving the plurality of catalogs from at least one web server. Further, the at least one web server hosts a plurality of websites of the plurality of stores. Further, the plurality of catalogs may be comprised in a plurality of webpages of the plurality of websites.

Further, in some embodiments, the processing device 204 may be configured for configuring a web crawler using the at least one product identifier. Further, the web crawler may be configured for identifying the plurality of catalogs comprised in the plurality of webpages of the plurality of websites based on the configuring. Further, the retrieving of the plurality of catalogs from the at least one web server may be based on the identifying of the plurality of catalogs.

Further, in some embodiments, the plurality of websites associated with the plurality of stores may be dissimilar.

Further, in some embodiments, the at least one product information may include a price of each product of the plurality of products. Further, the analyzing of the plurality of the at least one product information may include analyzing a plurality of the price associated with the plurality of products. Further, the at least one metric may include at least one price metric. Further, the determining of the at least one value for the at least one metric may include determining the at least one value for the at least one price metric. Further, the at least one category may include a lowest price category. Further, the determining of the goodness of the deal associated with each product of the plurality of products in the at least one category may include determining the goodness of the deal associated with each product of the plurality of products in the lowest price category based on the determining of the at least one value for the at least one price metric.

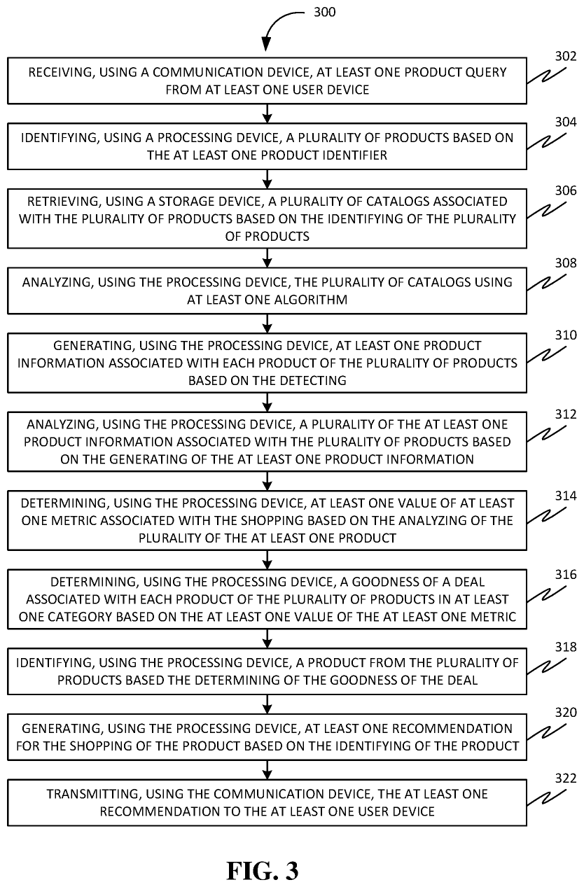

FIG. 3 is a flowchart of a method 300 for facilitating providing assistance to a user with shopping, in accordance with some embodiments. Accordingly, at 302, the method 300 may include receiving, using a communication device (such as the communication device 202), at least one product query from at least one user device. Further, the at least one product query may include at least one product identifier. Further, the at least one product query may include a product's description. Further, the at least one product identifier may include a product's name, a product's image, a product's code, etc. Further, the at least one user device may include a smartphone, a tablet, a desktop, a laptop, a smartwatch, etc.

Further, at 304, the method 300 may include identifying, using a processing device (such as the processing device 204), a plurality of products based on the at least one product identifier. Further, the plurality of products may include items, articles, apparel, clothes, etc. Further, the plurality of products may be similar. Further, the plurality of products may be sold from a plurality of stores.

Further, at 306, the method 300 may include retrieving, using a storage device (such as the storage device 206), a plurality of catalogs associated with the plurality of products based on the identifying of the plurality of products. Further, the plurality of catalogs may include product names, product brands, product specifications, product media, product prices, product reviews, product feedbacks, product offers, product ambassadors, product sale statistics, product sales records, product purchase records, etc. of the plurality of products. Further, the plurality of catalogs may include publications, brochures, pamphlets, booklets, leaflets, circulars, flyers, webpages, etc. of the plurality of products.

Further, at 308, the method 300 may include analyzing, using the processing device, the plurality of catalogs using at least one algorithm. Further, the at least one algorithm may include at least one computer vision algorithm. Further, the at least one computer vision algorithm may be configured for detecting one or more product information objects present in each catalog of the plurality of catalogs. Further, the at least one computer vision algorithm recognizes the one or more product information objects. Further, the one or more product information objects may include one or more objects that contain one or more information about the product names, the product brands, the product specifications, the product media, the product prices, the product reviews, the product feedbacks, the product offers, the product ambassadors, the product sale statistics, the product sales records, the product purchase records, etc.

Further, at 310, the method 300 may include generating, using the processing device, at least one product information associated with each product of the plurality of products based on the detecting. Further, the at least one product information may include a product's name, a product's brand, a product's price, a product's media, a product's specification, a product's review, a product's offer, a product's feedback, a product's sale statistic, a product's ambassador, etc.

Further, at 312, the method 300 may include analyzing, using the processing device, a plurality of the at least one product information associated with the plurality of products based on the generating of the at least one product information.

Further, at 314, the method 300 may include determining, using the processing device, at least one value of at least one metric associated with the shopping based on the analyzing of the plurality of the at least one product. Further, the at least one metric may include a customer rating metric, a product demand metric, a product affinity metric, a product sales metric, a customer satisfaction metric, a product quality metric, a product discount metric, a product expiration date metric, a product brand affinity metric, a product selling price metric, a product listed price metric, a product price metric, etc.

Further, at 316, the method 300 may include determining, using the processing device, a goodness of a deal associated with each product of the plurality of products in at least one category based on the at least one value of the at least one metric. Further, the goodness may include likeness, agreeableness, preference, etc. Further, the at least one category may include a lowest price category, a high-quality category, a popularity category, a trending category, a sponsoring category, a brand category, an endorsement entity category, etc.

Further, at 318, the method 300 may include identifying, using the processing device, a product from the plurality of products based on the determining of the goodness of the deal.

Further, at 320, the method 300 may include generating, using the processing device, at least one recommendation for the shopping of the product based on the identifying of the product. Further, the at least one recommendation may include at least one product information associated with the product.

Further, at 322, the method 300 may include transmitting, using the communication device, the at least one recommendation to the at least one user device.

Further, in some embodiments, the at least one algorithm may include at least one smart machine learning positioning algorithm. Further, the at least one smart machine learning positioning algorithm may be configured for determining at least one of a visual feature of each product information object of the one or more product information objects and a position of each product information object of the one or more product information objects in each catalog of the plurality of catalogs based on the detecting. Further, the visual feature may include a shape, a color, a design, a frame, a texture, a format, a style, etc. Further, the position may include a corner position, a center position, a side position, a top position, a bottom position, etc. Further, the at least one smart machine learning positioning algorithm may be configured for classifying the one or more product information objects into one or more information types based on at least one of the visual feature and the position of each product information object of the one or more product information objects. Further, the one or more information types may include names, brands, specifications, media, prices, reviews, feedbacks, offers, ambassadors, sale statistics, sales records, etc. Further, the at least one smart machine learning positioning algorithm may be configured for identifying at least one product information object associated with at least one predetermined information type from each catalog of the plurality of catalogs based on the classifying. Further, the generating of the at least one product information may be based on the identifying of the at least one product information object.

Further, in some embodiments, the one or more product information objects may include one or more media objects present in each catalog of the plurality of catalogs. Further, the one or more media objects contains the product media. Further, the product media may include graphical content, video content, audio content, etc. Further, the detecting of the one or more product information objects may include detecting the one or more media objects. Further, the generating of the at least one product information may be based on the detecting of the one or more media objects.

Further, in some embodiments, the at least one algorithm may include at least one media-to-text conversion algorithm. Further, the at least one media-to-text conversion algorithm may be configured for converting the one or more media objects into one or more textual objects based on the detecting of the one or more media objects. Further, the one or more textual objects may include textual content. Further, the generating of the at least one product information may be based on the converting.

Further, in some embodiments, the retrieving of the plurality of catalogs may include retrieving the plurality of catalogs from at least one web server. Further, the at least one web server hosts a plurality of websites of the plurality of stores. Further, the plurality of catalogs may be comprised in a plurality of webpages of the plurality of websites.

Further, the method 300 may include configuring, using the processing device, a web crawler using the at least one product identifier. Further, the web crawler may be configured for identifying the plurality of catalogs comprised in the plurality of webpages of the plurality of websites based on the configuring. Further, the retrieving of the plurality of catalogs from the at least one web server may be based on the identifying of the plurality of catalogs.

Further, in some embodiments, the plurality of websites associated with the plurality of stores may be dissimilar.

Further, in some embodiments, the at least one product information may include a price of each product of the plurality of products. Further, the analyzing of the plurality of the at least one product information may include analyzing a plurality of the price associated with the plurality of products. Further, the at least one metric may include at least one price metric. Further, the determining of the at least one value for the at least one metric may include determining the at least one value for the at least one price metric. Further, the at least one category may include a lowest price category. Further, the determining of the goodness of the deal associated with each product of the plurality of products in the at least one category may include determining the goodness of the deal associated with each product of the plurality of products in the lowest price category based on the determining of the at least one value for the at least one price metric.

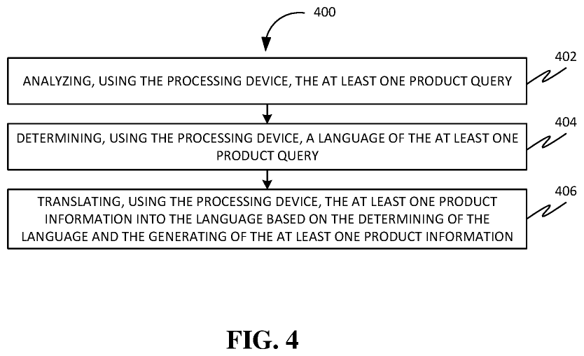

FIG. 4 is a flowchart of a method 400 for facilitating providing assistance to a user with shopping, in accordance with some embodiments. Accordingly, at 402, the method 400 may include analyzing, using the processing device, the at least one product query. Further, at 404, the method 400 may include determining, using the processing device, a language of the at least one product query. Further, the language may include a natural language. Further, the natural language may include English, Spanish, French, Chinese, Japanese, Korean, Portuguese, Hindi, etc. Further, at 406, the method 400 may include translating, using the processing device, the at least one product information into the language based on the determining of the language and the generating of the at least one product information. Further, the analyzing of the plurality of the at least one product information may be based on the translating.

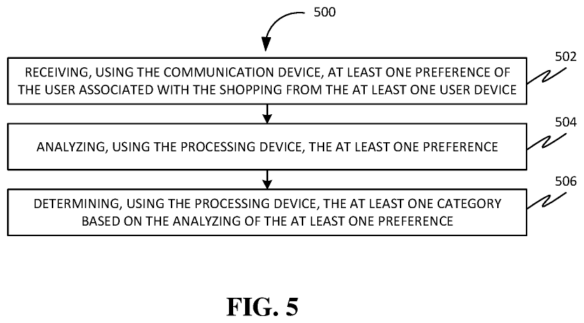

FIG. 5 is a flowchart of a method 500 for facilitating providing assistance to a user with shopping, in accordance with some embodiments. Accordingly, at 502, the method 500 may include receiving, using the communication device, at least one preference of the user associated with the shopping from the at least one user device. Further, the at least one preference may include a preferred brand, a preferred quality, a preferred ambassador, a preferred specification, a preferred price, etc.

Further, at 504, the method 500 may include analyzing, using the processing device, the at least one preference.

Further, at 506, the method 500 may include determining, using the processing device, the at least one category based on the analyzing of the at least one preference. Further, the determining of the goodness of the deal associated with each product of the plurality of products in the at least one category may be based on the determining of the at least one category.

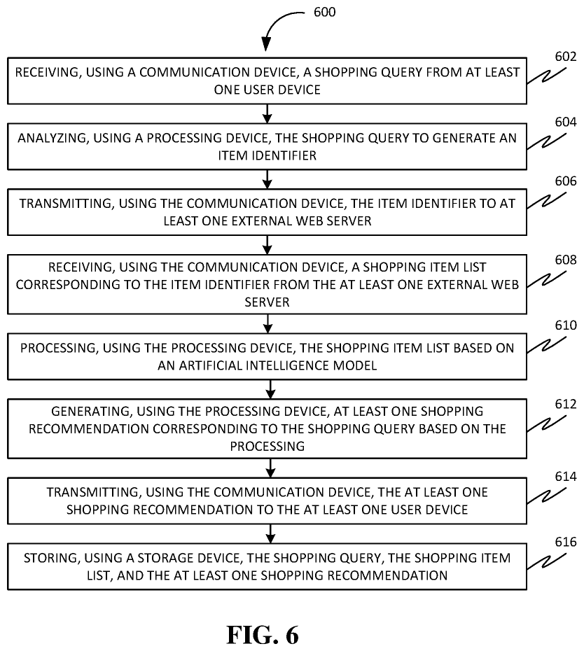

FIG. 6 is a flowchart of a method 600 for assisting a user with online shopping, in accordance with some embodiments. Accordingly, at 602, the method 600 may include a step of receiving, using a communication device, a shopping query from at least one user device. Further, the at least one user device may include a smartphone, a mobile, a tablet, a laptop, and so on. Further, the at least one user device may be associated with at least one user. Further, the shopping query may include a request for shopping at least one item that the at least one user may want to shop. Further, in an instance, the at least one item may include a shoe.

Further, at 604, the method 600 may include a step of analyzing, using a processing device, the shopping query to generate an item identifier. Further, the item identifier may include item information associated with the at least one item that the at least one user may want to shop. Further, the item information may include at least one of an item name, size, color, composition, price, brand, shipping cost, etc. Further, in an instance, the item identifier corresponding to the shoe may include a brand name Puma™, a black color, a sports shoe, etc.

Further, at 606, the method 600 may include a step of transmitting, using the communication device, the item identifier to at least one external web server. Further, the at least one external web server may be associated with at least one electronic commerce website.

Further, at 608, the method 600 may include a step of receiving, using the communication device, a shopping item list corresponding to the item identifier from the external web server. Further, the shopping item list may include a plurality of items that may be associated with the at least one item. Further, the shopping item list may include an information associated with each item of the plurality of items. Further, the information may include at least one of an item name, size, color, composition, brand, item category, price, item photo, reviews, shipping cost, etc. Further, in an instance, the shopping item list may include a plurality of black Puma™ sports shoe that may be available for purchase on the at least one electronic commerce website.

Further, at 610, the method 600 may include a step of processing, using the processing device, the shopping item list based on an artificial intelligence model. Further, the artificial intelligence model may be trained using at least one of at least one historical shopping query, at least one historical shopping item list, and at least one historical shopping recommendation. Further, the artificial intelligence model may be associated with a machine learning positioning algorithm. Further, the artificial intelligence model may use at least one of computer vision and picture to text recognition (or Optical Character Recognition) for facilitating processing the shopping item list.

Further, at 612, the method 600 may include a step of generating, using the processing device, at least one shopping recommendation corresponding to the shopping query based on the processing. Further, the at least one shopping recommendation may include the information associated with the at least one item.

Further, at 614, the method 600 may include a step of transmitting, using the communication device, the at least one shopping recommendation to the at least one user device.

Further, at 616, the method 600 may include a step of storing, using a storage device, at least one of the shopping query, the shopping item list, and the at least one shopping recommendation.

Further, in some embodiments, the method 600 may include a step of receiving, using the communication device, user click data from the at least one user device. Further, the method 600 may include a step of analyzing, using the processing device, the user click data. Further, the generating of the at least one shopping recommendation may be based on the analyzing of the user click data. Further, the user click data may include cache data that may be received from the at least one electronic commerce website.

Further, in some embodiments, the method 600 may include a step of receiving, using the communication device, at least one user preference associated with the at least one item from the at least one user device. Further, the at least one user preference may include at least one of an item name, size, color, composition, brand, item category, shipping cost, price, item photo, reviews, etc. Further, the method 600 may include a step of modifying, using the processing device, the shopping item list based on the at least one user preference. Further, the method 600 may include a step of generating, using the processing device, a modified shopping item list based on the modifying. Further, the method 600 may include a step of transmitting, using the communication device, the modified shopping item list to the at least one user device. Further, the method 600 may include a step of storing, using the storage device, the modified shopping item list.

Further, in some embodiments, the generating of the at least one shopping recommendation may be based on the modified shopping item list.

Further, in some embodiments, the at least one user device may include a camera configured for generating gaze information associated with the at least one user. Further, the camera may be configured for monitoring eye movement of the at least one user that may be viewing at least one web page associated with the at least one electronic commerce website using the at least one user device. Further, the at least one web page may include the at least one item and the item information. Further, the method 600 may include a step of receiving, using the communication device, the gaze information and the web page from the at least one user device. Further, the method 600 may include a step of analyzing, using the processing device, the gaze information and the web page. Further, the retraining of the artificial intelligence model may be based on the analyzing the gaze information and the web page.

Further, in some embodiments, the shopping query may be associated with a first language. Further, the at least one shopping recommendation may be associated with a second language. Further, the first language may be native to the at least one user. Further, the method 600 may include a step of translating, using the communication device, the at least one shopping recommendation to the first language. Further, the method 600 may include a step of generating, using the processing device, at least one translated shopping recommendation based on the translating. Further, the method 600 may include a step of transmitting, using the communication device, the at least one translated shopping recommendation to the at least one user device. Further, in an embodiment, the first language may be similar to the second language.

Further, in some embodiments, the method 600 may include a step of receiving, using the communication device, product information associated with at least one product from a store owner device. Further, the at least one product may correspond to the at least one item. Further, the store owner device may be associated with at least one store owner. Further, the product information may include at least one of a product name, a price, a brand, a category, a photo, etc. Further, the at least one store owner may include an individual, an institution, or an organization that may own at least one store/shop in a locality. Further, the at least one store owner device may include a smartphone, a tablet, a laptop, a personal computer, and so on. Further, the generating of the at least one shopping recommendation may be based on the product information.

Further, in some embodiments, the method 600 may include receiving, using the communication device, an informational video content corresponding to the at least one item from the at least one external web server. Further, the method 600 may include a step of analyzing, using the processing device, the informational video content based on the artificial intelligence model to determine at least one video information associated with the informational video content. Further, the at least one video information may include at least one of an item name, size, color, composition, brand, item category, price, photo, reviews, etc. Further, the generating of the at least one shopping recommendation may be based on the analyzing of the informational video content. Further, in an instance, the informational video content may include a video that may include a commercial advertisement associated with the at least one item.

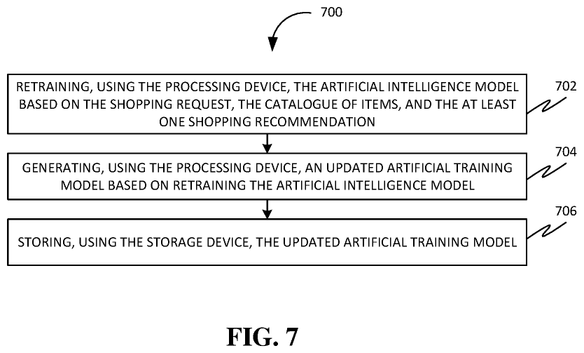

FIG. 7 is a flowchart of a method 700 for retraining the artificial intelligence model for assisting the user with online shopping, in accordance with some embodiments. Accordingly, at 702, the method 700 may include retraining, using the processing device, the artificial intelligence model based on the shopping query, the shopping item list, and the at least one shopping recommendation.

Further, at 704, the method 700 may include a step of generating, using the processing device, an updated artificial training model based on retraining the artificial intelligence model.

Further, at 706, the method 700 may include a step of storing, using the storage device, the updated training model. Further, the processing of the shopping item list may be based on the updated artificial training model.

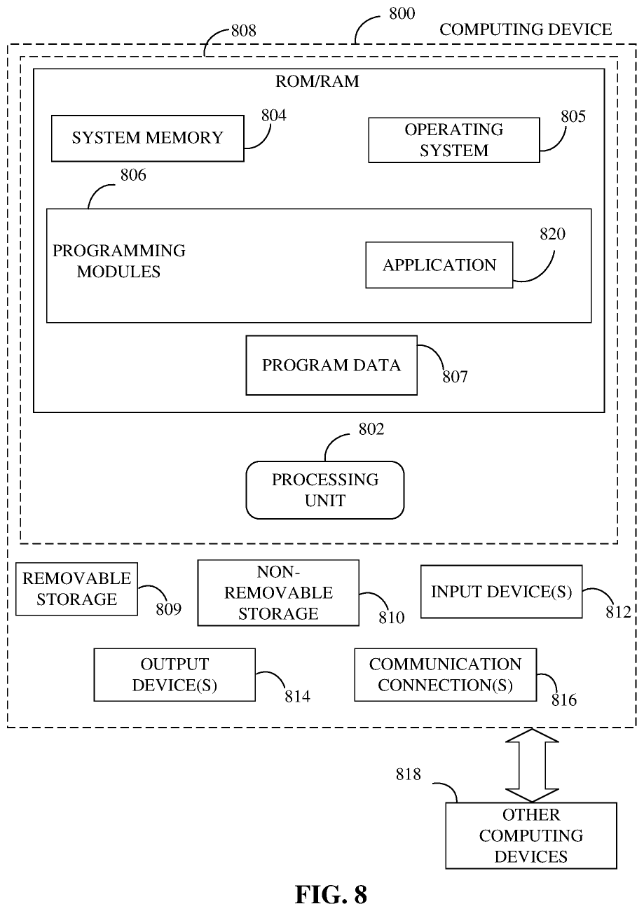

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include an image-processing module, machine learning module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and non-volatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, a location sensor, a camera, a biometric sensor, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820 such as a media player) may perform processes including, for example, one or more stages of methods, algorithms, systems, applications, servers, databases as described above. The aforementioned process is an example, and processing unit 802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method for facilitating providing assistance to a user with shopping, the method comprising:
receiving, using a communication device, at least one product query from at least one user device, wherein the at least one product query comprises at least one product identifier;
identifying, using a processing device, a plurality of products based on the at least one product identifier, wherein the plurality of products are similar, wherein the plurality of products are sold from a plurality of stores;
retrieving, using a storage device, a plurality of catalogs associated with the plurality of products based on the identifying of the plurality of products;
analyzing, using the processing device, the plurality of catalogs using at least one algorithm, wherein the at least one algorithm comprises at least one computer vision algorithm, wherein the at least one computer vision algorithm is configured for detecting one or more product information objects present in each catalog of the plurality of catalogs;
generating, using the processing device, at least one product information associated with each product of the plurality of products based on the detecting;
analyzing, using the processing device, a plurality of the at least one product information associated with the plurality of products based on the generating of the at least one product information;
determining, using the processing device, at least one value of at least one metric associated with the shopping based on the analyzing of the plurality of the at least one product;
determining, using the processing device, a goodness of a deal associated with each product of the plurality of products in at least one category based on the at least one value of the at least one metric;
identifying, using the processing device, a product from the plurality of products based on the determining of the goodness of the deal;
generating, using the processing device, at least one recommendation for the shopping of the product based on the identifying of the product, wherein the at least one recommendation comprises at least one product information associated with the product; and
transmitting, using the communication device, the at least one recommendation to the at least one user device.

2. The method of claim 1, wherein the at least one algorithm further comprises at least one smart machine learning positioning algorithm, wherein the at least one smart machine learning positioning algorithm is configured for:
determining at least one of a visual feature of each product information object of the one or more product information objects and a position of each product information object of the one or more product information objects in each catalog of the plurality of catalogs based on the detecting;
classifying the one or more product information objects into one or more information types based on at least one of the visual feature and the position of each product information object of the one or more product information objects; and
identifying at least one product information object associated with at least one predetermined information type from each catalog of the plurality of catalogs based on the classifying, wherein the generating of the at least one product information is further based on the identifying of the at least one product information object.

3. The method of claim 1, wherein the one or more product information objects comprises one or more media objects present in each catalog of the plurality of catalogs, wherein the detecting of the one or more product information objects comprises detecting the one or more media objects, wherein the generating of the at least one product information is further based on the detecting of the one or more media objects.

4. The method of claim 3, wherein the at least one algorithm further comprises at least one media-to-text conversion algorithm, wherein the at least one media-to-text conversion algorithm is configured for converting the one or more media objects into one or more textual objects based on the detecting of the one or more media objects, wherein the generating of the at least one product information is further based on the converting.

5. The method of claim 1 further comprising:
analyzing, using the processing device, the at least one product query;
determining, using the processing device, a language of the at least one product query; and
translating, using the processing device, the at least one product information into the language based on the determining of the language and the generating of the at least one product information, wherein the analyzing of the plurality of the at least one product information is further based on the translating.

6. The method of claim 1 further comprising:
receiving, using the communication device, at least one preference of the user associated with the shopping from the at least one user device;
analyzing, using the processing device, the at least one preference; and
determining, using the processing device, the at least one category based on the analyzing of the at least one preference, wherein the determining of the goodness of the deal associated with each product of the plurality of products in the at least one category is further based on the determining of the at least one category.

7. The method of claim 1, wherein the retrieving of the plurality of catalogs comprises retrieving the plurality of catalogs from at least one web server, wherein the at least one web server hosts a plurality of websites of the plurality of stores, wherein the plurality of catalogs is comprised in a plurality of webpages of the plurality of websites.

8. The method of claim 7 further comprising configuring, using the processing device, a web crawler using the at least one product identifier, wherein the web crawler is configured for identifying the plurality of catalogs comprised in the plurality of webpages of the plurality of websites based on the configuring, wherein the retrieving of the plurality of catalogs from the at least one web server is based on the identifying of the plurality of catalogs.

9. The method of claim 7, wherein the plurality of websites associated with the plurality of stores are dissimilar.

10. The method of claim 1, wherein the at least one product information comprises a price of each product of the plurality of products, wherein the analyzing of the plurality of the at least one product information comprises analyzing a plurality of the price associated with the plurality of products, wherein the at least one metric comprises at least one price metric, wherein the determining of the at least one value for the at least one metric comprises determining the at least one value for the at least one price metric, wherein the at least one category comprises a lowest price category, wherein the determining of the goodness of the deal associated with each product of the plurality of products in the at least one category comprises determining the goodness of the deal associated with each product of the plurality of products in the lowest price category based on the determining of the at least one value for the at least one price metric.

11. A system for facilitating providing assistance to a user with shopping, the system comprising:
a communication device configured for:
receiving at least one product query from at least one user device, wherein the at least one product query comprises at least one product identifier; and
transmitting at least one recommendation to the at least one user device;
a processing device communicatively coupled with the communication device, wherein the processing device is configured for:
identifying a plurality of products based on the at least one product identifier, wherein the plurality of products are similar, wherein the plurality of products are sold from a plurality of stores;
analyzing a plurality of catalogs using at least one algorithm, wherein the at least one algorithm comprises at least one computer vision algorithm, wherein the at least one computer vision algorithm is configured for detecting one or more product information objects present in each catalog of the plurality of catalogs;
generating at least one product information associated with each product of the plurality of products based on the detecting;
analyzing a plurality of the at least one product information associated with the plurality of products based on the generating of the at least one product information;
determining at least one value of at least one metric associated with the shopping based on the analyzing of the plurality of the at least one product;
determining a goodness of a deal associated with each product of the plurality of products in at least one category based on the at least one value of the at least one metric;
identifying a product from the plurality of products based on the determining of the goodness of the deal; and
generating the at least one recommendation for the shopping of the product based on the identifying of the product, wherein the at least one recommendation comprises at least one product information associated with the product; and
a storage device communicatively coupled with the processing device, wherein the storage device is configured for retrieving the plurality of catalogs associated with the plurality of products based on the identifying of the plurality of products.

12. The system of claim 11, wherein the at least one algorithm further comprises at least one smart machine learning positioning algorithm, wherein the at least one smart machine learning positioning algorithm is configured for:
determining at least one of a visual feature of each product information object of the one or more product information objects and a position of each product information object of the one or more product information objects in each catalog of the plurality of catalogs based on the detecting;
classifying the one or more product information objects into one or more information types based on at least one of the visual feature and the position of each product information object of the one or more product information objects; and
identifying at least one product information object associated with at least one predetermined information type from each catalog of the plurality of catalogs based on the classifying, wherein the generating of the at least one product information is further based on the identifying of the at least one product information object.

13. The system of claim 11, wherein the one or more product information objects comprises one or more media objects present in each catalog of the plurality of catalogs, wherein the detecting of the one or more product information objects comprises detecting the one or more media objects, wherein the generating of the at least one product information is further based on the detecting of the one or more media objects.

14. The system of claim 13, wherein the at least one algorithm further comprises at least one media-to-text conversion algorithm, wherein the at least one media-to-text conversion algorithm is configured for converting the one or more media objects into one or more textual objects based on the detecting of the one or more media objects, wherein the generating of the at least one product information is further based on the converting.

15. The system of claim 11, wherein the processing device is further configured for:
analyzing the at least one product query;
determining a language of the at least one product query; and
translating the at least one product information into the language based on the determining of the language and the generating of the at least one product information, wherein the analyzing of the plurality of the at least one product information is further based on the translating.

16. The system of claim 11, wherein the communication device is further configured for receiving at least one preference of the user associated with the shopping from the at least one user device, wherein the processing device is further configured for:
analyzing the at least one preference; and
determining the at least one category based on the analyzing of the at least one preference, wherein the determining of the goodness of the deal associated with each product of the plurality of products in the at least one category is further based on the determining of the at least one category.

17. The system of claim 11, wherein the retrieving of the plurality of catalogs comprises retrieving the plurality of catalogs from at least one web server, wherein the at least one web server hosts a plurality of websites of the plurality of stores, wherein the plurality of catalogs is comprised in a plurality of webpages of the plurality of websites.

18. The system of claim 17, wherein the processing device is further configured for configuring a web crawler using the at least one product identifier, wherein the web crawler is configured for identifying the plurality of catalogs comprised in the plurality of webpages of the plurality of websites based on the configuring, wherein the retrieving of the plurality of catalogs from the at least one web server is based on the identifying of the plurality of catalogs.

19. The system of claim 17, wherein the plurality of websites associated with the plurality of stores are dissimilar.

20. The system of claim 11, wherein the at least one product information comprises a price of each product of the plurality of products, wherein the analyzing of the plurality of the at least one product information comprises analyzing a plurality of the price associated with the plurality of products, wherein the at least one metric comprises at least one price metric, wherein the determining of the at least one value for the at least one metric comprises determining the at least one value for the at least one price metric, wherein the at least one category comprises a lowest price category, wherein the determining of the goodness of the deal associated with each product of the plurality of products in the at least one category comprises determining the goodness of the deal associated with each product of the plurality of products in the lowest price category based on the determining of the at least one value for the at least one price metric.
